(19) United States
(12) Patent Application Publication
(10) Pub. No.: US 2026/0209061 A1
(43) Pub. Date: Jul. 23, 2026

(54) MATERIALS, METHODS AND TECHNIQUES FOR THE SELECTIVE EXTRACTION OF CERIUM FROM PRASEODYMIUM CHLORIDE SOLUTIONS

(71) Applicant: Lynas Rare Earths Limited, East Perth WA (AU)

(72) Inventors: Muhammad Khair Khadri, Temerloh (MY); Luke Darbyshire, Roleystone (AU); Nurfarahiyah Abd Udzir, Kuantan (MY); Ruslinda A Rahim, Kuantan (MY)

(21) Appl. No.: 19/032,624

(22) Filed: Jan. 21, 2025

(51) Int. Cl. C01F 17/271

(52) U.S. Cl. CPC C01F 17/271; C01P 2006/80

(57) ABSTRACT

Praseodymium chloride solution depleted of cerium may be prepared by adjusting the pH of a high cerium-praseodymium chloride solution using praseodymium oxide, adding an oxidation agent comprising a hydrogen peroxide (H₂O₂) solution, to form a slurry mixture, filtering, and generating; a low cerium praseodymium chloride filtrate; and a praseodymium oxide solid containing cerium (IV) hydroxide; from the slurry mixture.

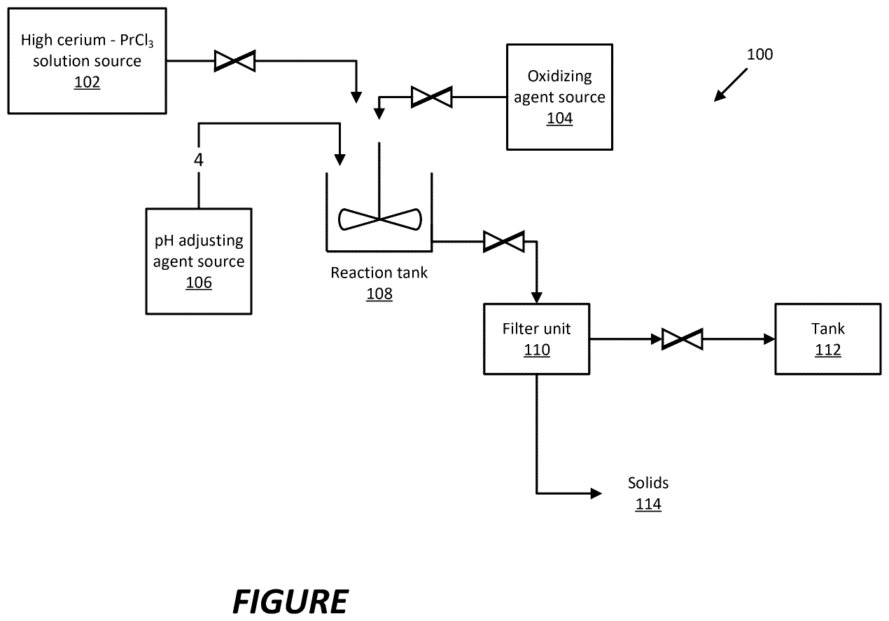

### TECHNICAL FIELD

The present disclosure relates to praseodymium chloride solutions. More specifically, materials, systems, and methods disclosed and contemplated herein relate to production of praseodymium chloride solutions from which cerium has undergone selective extraction.

### INTRODUCTION

Unrefined rare earths may be obtained through the processing of mining rare earth minerals. These mined rare earth minerals are processed in a sequential manner until they are of a form that may be used as an input to rare earth separation processes, such as solvent extraction. In these sequential processes, the rare earth element mixture is separated into individual rare earth compounds. The outputs of the sequential separation of rare earths are purified rare earth compounds, such as purified rare earth chlorides.

One such example of a separated rare earth compound is praseodymium chloride. Using a solvent extraction process to separate rare earths, under proper conditions, solvent extraction is capable of achieving rare earth chloride purities greater than 99% on a total rare earth oxide basis (or TREO). However, one of the most common rare earth impurities found in these separated rare earth chloride solutions is cerium.

In some applications, the presence of cerium is very undesirable. Thus, the complete removal of cerium in a purified rare earth solution is preferable. Cerium impurities may be further separated from rare earth solutions by subsequent solvent extraction stages, liquid chromatography, or ion exchange. Other purification methods may be considered.

Selective oxidation is one method that has been commonly used to remove cerium during upstream processes. For example, when the rare earth mineral bastnasite is heated in air at 650° C., Ce(III) is oxidized to Ce(IV). When the calcine is subsequently dissolved using 30% hydrochloric acid, cerium remains as an insoluble solid oxide residue, CeO₂, while the remainder of the rare earth elements are dissolved into solution. Cerium impurities may be removed from rare earth solutions by oxidation of soluble Ce(III) to insoluble Ce(IV). Oxidation may be accomplished using heat for solid mixtures or oxidation agents such as oxygen, ozone, hydrogen peroxide, hypochlorite, chlorite, chlorate, and perchlorate, for solutions.

Hydrogen peroxide is a strong oxidizer in acidic solution with an electrochemical potential of 1.5 V. Under acidic conditions, hydrogen peroxide is able to oxidize Ce(III) to Ce(IV) by the electrochemical reaction scheme (1):

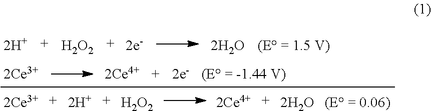

However, under strongly acidic conditions, Ce(III) is the favoured solution species and Ce(IV) is reduced back to Ce(III). Thus, reaction of Ce(III) is stabilized under strong acid conditions. Once formed, Ce(IV) hydrolyses and forms Ce(IV) hydroxide, which is insoluble.

### SUMMARY

In some aspects, the techniques described herein relate to a method for preparing a praseodymium chloride solution depleted of cerium, the method including: mixing a high cerium-praseodymium chloride solution with a pH adjustment agent including praseodymium oxide (Pr₆O₁₁), thereby generating a mixture; adding an oxidation agent to the mixture thereby generating a slurry including insoluble cerium (IV), the oxidation agent including hydrogen peroxide (H₂O₂); and filtering the slurry, thereby generating a depleted cerium-praseodymium chloride filtrate and a praseodymium oxide with cerium (IV) hydroxide solid.

In some aspects, the techniques described herein relate to a system for generating depleted cerium-praseodymium chloride solutions, the system including: a vessel in communication with a high cerium-praseodymium chloride solution source, a praseodymium oxide (Pr₆O₁₁) source, and a hydrogen peroxide (H₂O₂) source, the vessel including agitation apparatus, temperature controller, and pH probe; and a filter unit in fluid communication with the vessel.

There is no specific requirement that a material, technique, or method relating to depleted cerium-praseodymium chloride solutions include all the details characterized herein to obtain some benefit according to the present disclosure. Thus, the specific examples characterized herein are meant to be exemplary applications of the techniques described, and alternatives are possible.

### BRIEF DESCRIPTION OF THE DRAWINGS

The FIGURE is a schematic depiction of an exemplary system for generating depleted cerium-praseodymium chloride solutions.

### DETAILED DESCRIPTION

Materials, methods, and techniques disclosed and contemplated herein relate to generating a depleted cerium mixed rare earth chloride solution. Exemplary depleted cerium-praseodymium chloride may be generated with cerium removal operations. These operations may be performed as continuous processes. Exemplary depleted cerium-praseodymium chloride solution may have greater than 99% removal of cerium from a high cerium-praseodymium chloride solution.

### I. DEFINITIONS

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The modifiers “about” or “approximately” used in connection with a quantity are inclusive of the stated value and has the meaning dictated by the context (for example, it includes at least the degree of error associated with the measurement of the quantity). These modifiers should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

For the recitation of numeric ranges herein, each intervening number there between with the same degree of precision is contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are contemplated. For another example, when a pressure range is described as being between ambient pressure and another pressure, a pressure that is ambient pressure is expressly contemplated.

Definitions of specific functional groups and chemical terms are described in more detail below. For purposes of this disclosure, the chemical elements are identified in accordance with the Periodic Table of the Elements, CAS version, Handbook of Chemistry and Physics, 104^{th} Ed., inside cover, and specific functional groups are defined as described therein.

### II. EXEMPLARY MATERIALS

Exemplary methods and techniques use and generate various materials. Example materials include high cerium-praseodymium chloride solutions, depleted cerium-praseodymium chloride solutions, oxidation agents comprising hydrogen peroxide (H₂O₂) solutions, and pH adjusting agents comprising praseodymium oxide (Pr₆O₁₁).

### A. Exemplary High Cerium-Praseodymium Chloride Solutions

Exemplary high cerium-praseodymium chloride solutions are solutions comprising praseodymium chloride and cerium as a rare earth impurity. As used herein, “high cerium” is simply a relative term comparing praseodymium chloride solutions before and after treatment, where solutions after treatment are termed “depleted cerium” solutions.

In some instances, high cerium-praseodymium chloride solutions are generated from solvent extraction unit operations. Exemplary high cerium-praseodymium chloride solutions may have a pH less than 1.5; less than 1.25; less than 1.0; less than 0.75; less than 0.5; or less than 0.25. In various instances, high cerium-praseodymium chloride solutions may have a pH between 0.1 and 1.5; between 0.1 and 1.0; between 0.1 and 0.5; or between 0.5 and 1.0.

Various rare earths may be present in high cerium-praseodymium chloride solutions. For instance, high cerium-praseodymium chloride solutions typically include the rare earths praseodymium and cerium. Praseodymium and cerium may be present as oxides: Pr₆O₁₁ and CeO₂, respectively. In some instances, high cerium-praseodymium chloride solutions may additionally comprise lanthanum, neodymium, or combinations thereof. Lanthanum and neodymium may be present as oxides: La₂O₃ and Nd₂O₃, respectively.

In some instances, the concentration of total rare earths in high cerium-praseodymium chloride solutions is between 0.5 and 2 moles per liter total rare earth oxide (TREO/L). In various implementations, the concentration of total rare earths in high cerium-praseodymium chloride solutions is between 1.0 and 2.0 moles TREO/L; between 1.0 and 1.5 mole TREO/L; between 1.5 and 2.0 TREO/L; between 1.2 and 1.6 TREO/L; or between 1.3 and 1.5 TREO/L. In various implementations, high cerium-praseodymium chloride solutions may have a rare earth concentration of no less than 0.50 moles TREO/L; no less than 0.75 moles TREO/L; no less than 1.0 moles TREO/L; no less than 1.25 moles TREO/L; no less than 1.50 moles TREO/L; or no less than 1.75 moles TREO/L. In various implementations, high cerium-praseodymium chloride solutions may have a rare earth concentration of no greater than 2.0 moles TREO/L; no greater than 1.75 moles TREO/L; no greater than 1.5 moles TREO/L; no greater than 1.25 moles TREO/L; no greater than 1.0 moles TREO/L; no greater than 0.75 moles TREO/L; or no greater than 0.5 moles TREO/L.

In some instances, the concentration of cerium in high cerium-praseodymium chloride solution is between 500 ppm and 5000 ppm. In various implementations, high cerium-praseodymium chloride solutions may have a cerium concentration between 500 ppm and 5000 ppm; between 500 ppm and 3000 ppm; between 3000 ppm and 5000 ppm; between 1000 ppm and 4000 ppm; or between 2000 ppm and 3000 ppm. In various implementations, high cerium-praseodymium chloride solutions may have a cerium concentration of no less than 500 ppm, no less than 1000 ppm, no less than 2000 ppm, no less than 3000 ppm, no less than 4000 ppm, or no less than 5000 ppm. In various implementations, high cerium-praseodymium chloride solutions may have a cerium concentration no greater than 5000 ppm; no greater than 4500 ppm; no greater than 3500 ppm; no greater than 2500 ppm; no greater than 1500 ppm; or no greater than 500 ppm.

### B. Exemplary Depleted Cerium-Praseodymium Chloride Solutions

Exemplary depleted cerium-praseodymium chloride solutions are solutions comprising at least 98 wt % purity (on a TREO basis) praseodymium oxide (Pr₆O₁₁).

Exemplary praseodymium chloride solutions with “depleted cerium” are distinguished from solutions with “high cerium” in terms of cerium removal rate. In various implementations, exemplary depleted cerium-praseodymium chloride solutions comprise between 0.1% and 4%, by weight, of the cerium present in the high cerium-praseodymium chloride solutions. Put another way, at least 96 wt % of the cerium in high cerium-praseodymium chloride solutions may have been removed in exemplary depleted cerium-praseodymium chloride solutions.

In various implementations, exemplary depleted cerium-praseodymium chloride solutions may have a cerium removal rate of at least 90 wt %; at least 96 wt %; at least 97 wt %; at least 98 wt %; or at least 99 wt %, relative to the amount of cerium in the corresponding high cerium-praseodymium chloride solutions. In various implementations, exemplary depleted cerium-praseodymium chloride solutions may have a cerium removal rate between 90 wt % and 99.5 wt %; between 96 wt % and 99.5 wt %; between 96 wt % and 98 wt %; between 98 wt % and 99.5 wt %; between 97 wt % and 99 wt %; or between 99 wt % and 99.5 wt %.

In some instances, the concentration of cerium in depleted cerium-praseodymium chloride solution is between 30 ppm and 2000 ppm; between 100 ppm and 2000 ppm; between 500 ppm and 2000 ppm; or between 1000 ppm and 2000 ppm. In various implementations, praseodymium chloride solutions with depleted cerium may have a cerium concentration of no less than 30 ppm; no less than 100 ppm; no less than 1000 ppm; no less than 1500 ppm; or no less than 2000 ppm. In various implementations, depleted cerium-praseodymium chloride solutions may have a cerium concentration of no more than 2000 ppm; no more than 1500 ppm; no more than 1000 ppm; no more than 750 ppm; no more than 500 ppm; no more than 250 ppm; no more than 100 ppm; or no more than 30 ppm.

### C. Exemplary Hydrogen Peroxide Solutions

Exemplary oxidation agents may comprise hydrogen peroxide (H₂O₂) solutions. In some instances, exemplary oxidation agents consist essentially of hydrogen peroxide (H₂O₂) solution. In some instances, exemplary oxidation agents consist of hydrogen peroxide (H₂O₂) solution.

In some instances, a concentration of the hydrogen peroxide (H₂O₂) solution may be about 5 wt. % to about 30 wt. %. In various implementations, a concentration of the hydrogen peroxide (H₂O₂) solution may be at least 10 wt. %; at least 20 wt. %; or at least 30 wt. %. In various implementations, a concentration of the hydrogen peroxide (H₂O₂) solution may be no more than 30 wt. %; no more than 20 wt. %; or no more than 10 wt. %. In various implementations, a concentration of the hydrogen peroxide (H₂O₂) solution may be 5-10 wt. %; 10-20 wt. %; or 20-30 wt. %.

### D. Exemplary pH Adjustment Agents

Exemplary pH adjustment agents are typically basic. In some implementations, exemplary pH adjustment agents comprise praseodymium oxide (Pr₆O₁₁). In some instances, praseodymium oxide (Pr₆O₁₁) is added as a solid.

In some implementations, exemplary pH adjustment agents consist essentially of praseodymium oxide. In some implementations, exemplary pH adjustment agents consist of praseodymium oxide. Without being bound by a particular theory, it is hypothesized that using basic material that does not include praseodymium, such as sodium hydroxide, may introduce undesired impurities.

### III. EXAMPLE METHODS

Example methods for preparing depleted cerium-praseodymium chloride solutions disclosed and contemplated herein can include one or more operations. Broadly, exemplary methods include one or more temperature adjustment and mixing operations, one or more pH adjustment operations, one or more oxidation operations, and one or more filtering operations. In various implementations, some, most, or all operations in exemplary methods may be arranged and performed continuously (i.e., not in a batch operation).

An example method may begin by heating the high cerium-praseodymium chloride solution. Exemplary high cerium-praseodymium chloride solutions are described in greater detail above. Temperature adjusting equipment may be used to raise the temperature of the solution. The high cerium-praseodymium chloride solution may be agitated during temperature adjustment.

The example method may comprise raising a temperature of high cerium-praseodymium chloride solution to be between about 60° C. and about 90° C. In some instances, the temperature of high cerium-praseodymium chloride solution may be adjusted to be between 60° C. and 65° C.; between 65° C. and 70° C.; between 70° C. and 75° C., between 75° C. and 80° C., between 80° C. and 85° C., between 70° C. and 90° C.; or between 85° C. and 90° C. In some instances, the high cerium-praseodymium chloride solution temperature may be no less than 60° C.; no less than 65° C.; no less than 70° C.; no less than 75° C., no less than 80° C., no less than 85° C., or no less than 90° C. In some instances, the high cerium-praseodymium chloride solution temperature may be no more than 90° C.; no more than 85° C.; no more than 80° C.; no more than 75° C.; no more than 70° C., no more than 65° C., or no more than 60° C.

An example method may continue by adding a pH adjustment agent to the heated high cerium-praseodymium chloride solution. In some instances, the solid-liquid mixture is agitated while mixing the pH adjustment agent for a predetermined period of time.

Exemplary pH adjustment agents are described in greater detail above and may comprise solid praseodymium oxide (Pr₆O₁₁). In some instances, a concentration of praseodymium in the high cerium-praseodymium chloride solution may increase after adding the pH adjustment agent comprising praseodymium oxide (Pr₆O₁₁). Adding pH adjustment agent forms a slurry or liquid-solid mixture.

The total amount of pH adjustment agent added depends on the initial pH of the high cerium-praseodymium chloride solution. In some implementations, the initial pH is about less than 1.

In some implementations, the pH of the high cerium-praseodymium chloride solution is continuously monitored during the course of the pH adjustment with the pH adjustment solid.

In some implementations, pH adjustment agent is added to the high cerium-praseodymium chloride solution until achieving a target pH range of 3.8 to 5.0. In some implementations, a pH of the high cerium-praseodymium chloride solution, after adding pH adjustment agent, may be no less than 3.8; no less than 4.0; no less than 4.2; no less than 4.4; no less than 4.6; no less than 4.8, or no less than 5.0. In some implementations, a pH of the high cerium-praseodymium chloride solution, after adding pH adjustment agent, may be no more than 5.0; no more than 4.8; no more than 4.6; no more than 4.4; no more than 4.2, no more than 4.0; or no more than 3.8. For instance, a pH of the slurry mixture may be controlled to be between 3.8 and 5.0; between 4.0 and 5.0; between 4.0 and 4.8; between 4.0 and 4.6; between 4.0 and 4.4; between 4.0 and 4.2; between 4.2 and 5.0; between 3.8 and 4.2; between 4.2 and 4.8; between 4.2 and 4.6; between 4.2 and 4.4; between 4.4 and 5.0; or between 4.4 to 4.8; between 4.4 to 4.6; between 4.6 to 5.0; between 4.6 to 4.8; and between 4.8 to 5.0.

The example method may comprise agitating the mixture for a predetermined period of time. In some instances, the mixture may be agitated for a period of time between 1 hour and 10 hours; between 1 hour and 5 hours; between 5 hours and 10 hours; or between 3 hours and 7 hours. In various implementations, the mixture may be agitated for a period of time no less than 1 hour; no less than 2 hours; no less than 3 hours; no less than 5 hours; no less than 7 hours; no less than 9 hours; or no less than 10 hours. In various implementations, the mixture may be agitated for a period of time no more than 1 hour; no more than 2 hours; no more than 3 hours; no more than 5 hours; no more than 7 hours; no more than 9 hours; or no more than 10 hours.

The example method may comprise determining a concentration of cerium in the high cerium-praseodymium chloride solution. In some instances, the example method may include obtaining a sample of the high cerium-praseodymium chloride solution and subjecting that sample to one or more tests to determine cerium content. As an example, inductive coupled plasma optical emission (ICP-OES) or inductive coupled plasma mass spectrometry (ICP-MS) may be used to determine cerium content, although other methods known in the art may be used.

An example method may continue by adding an oxidation agent with mixing to the pH adjusted slurry of high cerium-praseodymium chloride solution. Adding oxidation agent to the slurry oxidizes cerium (III) to cerium (IV) hydroxide (Ce(OH)₄). As discussed in greater detail above, the cerium (III) species is dissolved, and the cerium (IV) species is insoluble.

In some implementations, the oxidation agent is a solution of hydrogen peroxide (H₂O₂). In some instances, the concentration of the hydrogen peroxide solution is about 30% weight/weight solution in water. In some instances, the concentration of the hydrogen peroxide solution is between 5% to 30%; between 10% to 30%; between 20% to 30%; or between 10% to 20%. In other instances, the concentration of the hydrogen peroxide solution is no more than 30%; or more than 20% or no more than 10%. In other instances, the concentration of the hydrogen peroxide solution is no less than 30%; no less than 20%; no less than 10%; or no less than 5%.

The example method may include controlling a slurry temperature to be between 50° C. and 90° C. during oxidation. In some instances, controlling the slurry temperature may include heating the slurry. In various implementations, during oxidation, the temperature of the slurry is maintained between 50° C. and 90° C.; between 50° C. and 70° C.; between 55° C. and 75° C.; between 60° C. and 80° C.; between 70° C. and 80° C.; between 70° C. and 75° C.; between 75° C. and 80° C.; or between 72° C. and 78° C. In various implementations, during oxidation, the temperature of the slurry is maintained to be no less than 50° C.; no less than 55° C.; no less than 60° C.; no less than 65° C.; no less than 70° C.; no less than 75° C.; no less than 80° C.; no less than 85° C.; or no less than 90° C. In various implementations, during oxidation, the temperature of the slurry is maintained to be no greater than 90° C.; no greater than 85° C.; no greater than 80° C.; no greater than 75° C.; no greater than 70° C.; no greater than 65° C.; no greater than 60° C.; no greater than 55° C.; or no greater than 50° C.

Various amounts of oxidation agent may be used. For instance, hydrogen peroxide (H₂O₂) may be added such that a molar ratio of cerium to hydrogen peroxide (H₂O₂) is between 2:1 and 1:13; between 2:1 and 1:1; between 0.9:1 and 1.1:1; between 1:1 and 1:2; between 1:2 and 1:3; between 1:3 and 1:4; between 1:4 and 1:5, between 1:5 and 1:6, between 1:6 and 1:7, between 1:7 and 1:8, between 1:8 and 1:9, between 1:9 and 1:10, between 1:10 and 1:11, between 1:11 and 1:12, or between 1:12 and 1:13 In various implementations, hydrogen peroxide (H₂O₂) may be added such that a molar ratio of cerium to hydrogen peroxide (H₂O₂) is no less than 2:1; no less than 1:1; no less than 1:2; no less than 1.32; no less than 1.4; no less than 1.5; no less than 1.6; no less than 1.7; no less than 1.7; no less than 1.9; no less than 1.10; no less than 1.11; no less than 1.12; or no less than 1.13. In various implementations, hydrogen peroxide (H₂O₂) may be added such that a molar ratio of cerium to hydrogen peroxide (H₂O₂) is no greater than 1:13; no greater than 1:12; no greater than 1:11; no greater than 1:10; no greater than 1:9; no greater than 1:8; no greater than 1:7; no greater than 1:6; no greater than 1:5; no greater than 1:4; no greater than 1:3; no greater than 1:2; no greater than 1:1; or no greater than 2:1.

The example method may include performing oxidation for a predetermined period of time. In some instances, oxidation may be conducted for a predetermined period of time between 1 hour and 3 hours; between 1.5 and 2.5 hours; between 1 hour and 2 hours; or between 2 hours and 3 hours. In some instances, oxidation may be conducted for a predetermined period of time no less than 1 hour; no less than 1.5 hours; no less than 2.0 hours; no less than 2.5 hours; or no less than 3.0 hours. In some instances, oxidation may be conducted for a predetermined period of time no greater than 3.0 hours; no greater than 2.75 hours; no greater than 2.25 hours; no greater than 1.75 hours; no greater than 1.25 hours; or no greater than 1.0 hours.

After oxidation and agitating operations, the example method may comprise filtering the oxidized depleted cerium-praseodymium chloride solution. Filtering may include removing solids from solution, where the solids comprise excess praseodymium oxide and cerium (IV) oxide/hydroxide. The solids portion may be referred to as praseodymium oxide filter cake.

Various filtration methods known in the art may be used. For instance, in some implementations, a pressure or vacuum filter may be used to separate the excess mixed praseodymium oxide and Ce(IV) hydroxide cake from the praseodymium chloride solution.

The filter cake is a praseodymium oxide solid comprising praseodymium oxide and cerium. In various instances, the filter cake may comprise one or more additional constituents, such as rare earth oxides. For example, the filter cake may comprise lanthanum oxide and or neodymium oxide in addition to praseodymium oxide and cerium.

In some instances, the filter cake is a praseodymium oxide solid comprising between about 0.9% to about 3% cerium as a percentage of total rare earth concentration. In various implementations, the filter cake is a praseodymium oxide solid comprising between 0.9% to 1%; between 1% and 1.5%; between 1.5% and 2%; between 2% and 2.5%, or between 2.5% and 3% cerium as a percentage of total rare earth concentration. In various implementations, the filter cake is a praseodymium oxide solid comprising no less than 0.9%; no less than 1.0%; no less than 1.5%; no less than 2.0%, no less than 2.5%, or no less than 3.0% cerium as a percentage of total rare earth concentration. In various implementations, the filter cake is a praseodymium oxide solid comprising no greater than 3.0%; no greater than 2.5%; no greater than 2.0%; no greater than 1.5%, no greater than 1.0%, or no greater than 0.9% cerium as a percentage of total rare earth concentration.

In various instances, filtration operations may generate a liquid filtrate comprising a depleted cerium-praseodymium chloride solution. As discussed in greater detail above, the depleted cerium-praseodymium chloride solution has been depleted of, in various instances, between 90% and 99% of the cerium in the high cerium-praseodymium chloride solution.

### IV. EXAMPLE SYSTEMS

The FIGURE is a schematic diagram of an exemplary system 100 for generating depleted cerium-praseodymium chloride solution. As shown, a high cerium-praseodymium chloride solution source 102 is in fluid communication with a reaction tank 108. The high cerium-praseodymium chloride solution source 102 is configured to selectively provide praseodymium chloride with high cerium to reaction tank 108.

An oxidation agent source 104 may be in fluid communication with reaction tank 108. Oxidation agent source 104 may be configured to selectively provide oxidation agent to reaction tank 108. As shown in the FIGURE, exemplary oxidation agent may comprise hydrogen peroxide (H₂O₂).

A pH adjusting agent source 106 may be in communication with reaction tank 108. Various apparatus may be used to convey solids to reaction tank 108. As shown in the FIGURE, solids conveyor 4 may be used to convey pH adjusting agent to reaction tank 108.

The pH adjusting agent source 106 may be configured to selectively provide pH adjusting agent to reaction tank 108. As shown in the FIGURE, exemplary pH adjusting agent may comprise praseodymium oxide (Pr₆O₁₁).

Reaction tank 108 may comprise an agitation apparatus configured to agitate reactor tank contents.

Reaction tank 108 may comprise temperature control apparatus, not shown, configured to maintain or control the temperature of reaction tank 108 contents. Temperature control apparatus may be configured to maintain a fluid temperature of reaction tank 108 contents at various temperatures as described in greater detail above with reference to methods of operation, such as between about 50° C. to about 90° C. In various instances, temperature control apparatus may be configured to maintain a fluid temperature of reaction tank 108 contents between 50° C. and 90° C.; between 50° C. and 60° C.; between 60° C. and 70° C.; between 70° C. and 80° C.; between 70° C. and 90° C.; or between 80° C. and 90° C. In various instances, temperature control apparatus may be configured to maintain a fluid temperature of reaction tank 108 contents to be no less than 50° C.; no less than 60° C.; no less than 70° C.; no less than 80° C.; or no less than 90° C. In various instances, temperature control apparatus may be configured to maintain a fluid temperature of reaction tank 108 contents to be no greater than 90° C.; no greater than 80° C.; no greater than 70° C.; no greater than 60° C.; or no greater than 50° C.

Reaction tank 108 may comprise pH control apparatus configured to maintain or control the pH of reaction tank 108 contents. In some instances, pH control apparatus may selectively provide pH adjusting agent and/or oxidation agent to reaction tank 108 to achieve target pH ranges. In some instances, pH control apparatus may comprise various components to measure and provide pH adjusting material, such as a pH probe(s), controller(s), valve(s), and pump(s).

Filter unit 110 is in fluid communication with, and receives material from, reaction tank 108. Filter unit 110 separates praseodymium oxide with cerium (IV) hydroxide filter cake from the depleted cerium-praseodymium chloride solution. In some instances, filter unit 110 may comprise a vacuum filter. Depleted cerium-praseodymium chloride solution may be provided to tank 112.

As shown in the FIGURE, praseodymium oxide with cerium (IV) hydroxide filter cake may be discharged from filter unit 110 and stockpiled as solids 114. In some instances, solids 114 comprise Pr₆O₁₁ and Ce(OH)₄.

### V. EXPERIMENTAL EXAMPLES

Several tests were conducted for cerium depletion operations in a design of experiments (DOE). The results are discussed below.

### A. Raw Materials and Chemicals

Table 1 below provides details of the composition of praseodymium chloride with high cerium solutions used in the design of experiments.

TABLE 1
Details about the composition of praseodymium chloride
with high cerium solutions used in Tests 1-4.

| | | Note: Result of Test 2 | | Note: Result of Test 4 | |
|---|---|---|---|---|---|
| | | is the repetition of | | is the repetition of | |
| | Unit of | analysis from Test 1 | | analysis from Test 3 | |
| Analyte | Measure | Test 1 | Test 2 | Test 3 | Test 4 |
| REO | moles/L | 1.349 | 1.349 | 1.391 | 1.391 |
| La₂O₃/REO | wt % | <0.001 | 0.001 | <0.001 | <0.001 |
| CeO₂/REO | wt % | 0.283 | 0.438 | 0.315 | 0.523 |
| Pr₆O₁₁/REO | wt % | 98.518 | 98.265 | 98.552 | 98.24 |
| Nd₂O₃/REO | wt % | 1.19 | 1.286 | 1.124 | 1.228 |
| pH | | <1.00 | <1.00 | 0.19 | 0.19 |

### B. Process Conditions

A high cerium-praseodymium chloride solution as shown in Table 1 was added into a vessel and agitated. A magnetic stirrer was used for mixing. The vessel contents were heated using a laboratory hot plate with temperature controller and maintained at temperature: 70° C.+/−2° C. The pH was continuously monitored using a pH probe. The pH was manually adjusted in the pH range (pH 4 to 5) by adding the pH adjustment solid, praseodymium oxide. For Tests 1 and 2, the process was stopped, and the reaction mixture was filtered using a vacuum filter to obtain a black filter cake and depleted cerium-praseodymium chloride filtrate. The wet filter cake was collected, and a portion of the cake was dried.

For Tests 3 and 4, the process continued after pH adjustment with the oxidation step. The temperature of the reaction mixture was maintained at 70° C.+/−2° C. during the oxidation step. The oxidation agent (30% H₂O₂ solution) was fed into the reaction mixture. Upon the initial addition of hydrogen peroxide, the viscosity of the reaction mixture increased. The oxidation reaction progressed, and additional hydrogen peroxide was added. The amount of H₂O₂ solution added was about 5 mL per 160 mL of praseodymium chloride (PrCl₃) solution and about 5 mL per 15 g praseodymium oxide (Pr₆O₁₁) added.

Along with the oxidation reaction, the mixture was stirred until the viscosity reduced, and the slurry mixture became fluid. The oxidation reaction was allowed to occur over a period of about two hours. After 2 hours, the dosing of the oxidation agent was stopped. The pH varied from 3.6 to 4.2 during the oxidation process while the temperature fluctuated between 70 to 86° C. Once the oxidation reaction had been completed, the reaction mixture for Tests 3 and 4 were filtered using vacuum filter to obtain a black filter cake and praseodymium chloride filtrate. The wet filter cake was collected, and a portion of the cake was dried.

### C. Cerium Depletion Operation Results

As shown in Table 1, the initial levels of cerium in praseodymium chloride solution ranged from 0.283 wt % CeO₂/REO to 0.523 wt % CeO₂/REO. After 2-hour cerium depletion operations, for Tests 1 and 2, which did not continue with the oxidation step, the cerium removal rates were 49% to 52% as shown in Table 2. For Tests 3 and 4 which continued with the oxidation step, the cerium removal rates were 97% to 99% as shown in Table 2.

TABLE 2
Details about the composition of praseodymium chloride with depleted
cerium solutions with respective removal rates from Tests 1-4.

| | | Note: Result of Test 2 | | Note: Result of Test 4 | |
|---|---|---|---|---|---|
| | | is the repetition of | | is the repetition of | |
| | | analysis from Test 1 | | analysis from Test 3 | |
| | Unit of | w/o Oxidation step | | w/ Oxidation | |
| Analyte | Measure | Test 1 | Test 2 | Test 3 | Test 4 |
| La₂O₃/REO | wt % | <0.001 | <0.001 | <0.001 | <0.001 |
| CeO₂/REO | wt % | 0.135 | 0.223 | 0.003 | 0.017 |
| Pr₆O₁₁/REO | wt % | 98.916 | 98.765 | 98.687 | 98.418 |
| Nd₂O₃/REO | wt % | 0.94 | 1.001 | 1.300 | 1.544 |
| pH | | 5.09 | 5.09 | 4.79 | 4.79 |
| REO | mol/L | 1.331 | 1.331 | 1.819 | 1.819 |
| Ce Removal | wt % | 52% | 49% | 99% | 97% |
| Rate | | | | | |

As shown in Table 3, the levels of cerium in praseodymium oxide dried filter cake ranged from 0.944% CeO₂/REO to 1.415% CeO₂/REO for Test 1 and 2 without oxidation step. For Test 3 and 4 with oxidation step, the levels of cerium in praseodymium oxide dried filter cake ranged from 1.923% CeO₂/REO to 2.808% CeO₂/REO in Table 3. There was roughly a 2× increase in efficiency of removal of cerium with the oxidation step versus without.

TABLE 3
Details about the REE composition of praseodymium
oxide filter cake with cerium from Tests 1-4.

| | | Note: Result of Test 2 | | Note: Result of Test 4 | |
|---|---|---|---|---|---|
| | | is the repetition of | | is the repetition of | |
| | | analysis from Test 1 | | analysis from Test 3 | |
| | Unit of | w/o Oxidation step | | w/ Oxidation | |
| Analyte | Measure | Test 1 | Test 2 | Test 3 | Test 4 |
| La₂O₃/REO | % | <0.001 | <0.001 | <0.001 | <0.001 |
| CeO₂/REO | % | 0.944 | 1.415 | 1.923 | 2.808 |
| Pr₆O₁₁/REO | % | 97.823 | 97.298 | 96.331 | 95.573 |
| Nd₂O₃/REO | % | 1.224 | 1.278 | 1.737 | 1.610 |

### Exemplary Embodiments

For reasons of completeness, various aspects of the technology are set out in the following numbered embodiments:

Embodiment 1. A method for preparing a praseodymium chloride solution depleted of cerium, the method comprising: mixing a high cerium-praseodymium chloride solution with a pH adjustment agent comprising praseodymium oxide (Pr₆O₁₁), thereby generating a mixture; adding an oxidation agent to the mixture thereby generating a slurry comprising insoluble cerium (IV), the oxidation agent comprising hydrogen peroxide (H₂O₂); and filtering the slurry, thereby generating a depleted cerium-praseodymium chloride filtrate and a praseodymium oxide with cerium (IV) hydroxide solid.
Embodiment 2. The method according to Embodiment 1, further comprising: agitating and heating while mixing the high cerium-praseodymium chloride solution with the pH adjustment agent; and agitating and heating the slurry.
Embodiment 3. The method according to Embodiment 1 or Embodiment 2, wherein a total rare earth oxide content of the high cerium-praseodymium chloride solution is between 1.0 and 2.0 moles per liter total rare earth oxide; and further comprising: agitating the mixture for a predetermined period of time,
Embodiment 4. The method according to Embodiment 3, wherein the predetermined period is 1 hour to 10 hours.
Embodiment 5. The method according to Embodiment 2, wherein the pH of the slurry during agitating is about 3.8 to 4.2.
Embodiment 6. The method according to any one of Embodiments 1-5, further comprising controlling the temperature of the slurry to be between 50° C. to 90° C.
Embodiment 7. The method according to any one of Embodiments 1-6, wherein mixing the high cerium-praseodymium chloride solution with the pH adjustment agent is performed continuously; wherein adding the oxidation agent is performed continuously; and wherein generating the depleted cerium-praseodymium chloride solution from the mixture is performed continuously.
Embodiment 8. The method according to any one of Embodiments 1-7, further comprising preparing the high cerium-praseodymium chloride solution by heating the high cerium-praseodymium chloride solution to a temperature between 70° C. and 90° C., where the high cerium-praseodymium chloride solution has a pH less than 1.
Embodiment 9. The method according to any one of Embodiments 1-8, further comprising determining a concentration of cerium in the high cerium-praseodymium chloride solution; and adding the oxidation agent such that a molar ratio of cerium to hydrogen peroxide (H₂O₂) is between 2:1 and 1:13.
Embodiment 10. The method according to Embodiment 9, the concentration of hydrogen peroxide (H₂O₂) being 20% to 30% weight/weight solution in water.
Embodiment 11. The method according to Embodiment 10, wherein adding the oxidation agent and agitating the slurry is performed for a time period between 1 hour and 3 hours.
Embodiment 12. The method according to Embodiment 9, wherein the molar ratio of cerium to hydrogen peroxide (H₂O₂) is between 0.9:1 and 1.1:1.
Embodiment 13. The method according to any one of Embodiments 1-12, wherein the depleted cerium-praseodymium chloride filtrate comprises between 0.1 wt % to 4 wt % of a cerium concentration in the high cerium-praseodymium chloride solution.
Embodiment 14. The method according to any one of Embodiments 1-13, wherein filtering generates a filter cake comprising the praseodymium oxide with cerium (IV) hydroxide solid; and wherein the filter cake is a praseodymium oxide solid with 0.9% to 3% of cerium as percentage of total rare earth concentration.
Embodiment 15. The method according to any one of Embodiments 1-14, wherein the depleted cerium-praseodymium chloride filtrate has at least 98 wt % purity praseodymium oxide (Pr₆O₁₁) on a total rare earth oxide basis.
Embodiment 16. A system for generating depleted cerium-praseodymium chloride solutions, the system comprising: a vessel in communication with a high cerium-praseodymium chloride solution source, a praseodymium oxide (Pr₆O₁₁) source, and a hydrogen peroxide (H₂O₂) source, the vessel comprising agitation apparatus; and a filter unit in fluid communication with the vessel.
Embodiment 17. The system according to Embodiment 16, the filter unit generating: a solids portion comprising praseodymium oxide solid containing 1 to 2 percent cerium per total rare earth oxides; and a liquid filtrate comprising a depleted cerium-praseodymium chloride solution with cerium removal rate between 97% to 99%.
Embodiment 18. The system according to Embodiment 16 or Embodiment 17, the vessel comprising temperature regulation components configured to maintain a vessel fluid temperature between about 70° C. to about 90° C.
Embodiment 19. The system according to any one of Embodiments 16-18, wherein the filter unit is a vacuum filter.
Embodiment 20. The system according to any one of Embodiments 16-19, further comprising pH control apparatus configured to maintain a pH of fluid in the vessel at a pH between 3.8 and 5.0.
It is understood that the foregoing detailed description and accompanying examples are merely illustrative and are not to be taken as limitations upon the scope of the disclosure. Various changes and modifications to the disclosed embodiments will be apparent to those skilled in the art. Such changes and modifications, including without limitation those relating to the chemical structures, substituents, derivatives, intermediates, syntheses, compositions, formulations, or methods of use, may be made without departing from the spirit and scope of the disclosure.

1. A method for preparing a praseodymium chloride solution depleted of cerium, the method comprising:
mixing a high cerium-praseodymium chloride solution with a pH adjustment agent comprising praseodymium oxide (Pr₆O₁₁), thereby generating a mixture;
adding an oxidation agent to the mixture thereby generating a slurry comprising insoluble cerium (IV), the oxidation agent comprising hydrogen peroxide (H₂O₂); and
filtering the slurry, thereby generating a depleted cerium-praseodymium chloride filtrate and a praseodymium oxide with cerium (IV) hydroxide solid.

2. The method according to claim 1, further comprising:
agitating and heating while mixing the high cerium-praseodymium chloride solution with the pH adjustment agent; and
agitating and heating the slurry.

3. The method according to claim 2, wherein a total rare earth oxide content of the high cerium-praseodymium chloride solution is between 1.0 and 2.0 moles per liter total rare earth oxide; and further comprising:
agitating the mixture for a predetermined period of time.

4. The method according to claim 3, wherein the predetermined period is 1 hour to 10 hours.

5. The method according to claim 2, wherein a pH of the slurry during agitating is about 3.8 to 4.2.

6. The method according to claim 2, further comprising controlling the temperature of the slurry to be between 70° C. to 90° C.

7. The method according to claim 2, wherein mixing the high cerium-praseodymium chloride solution with the pH adjustment agent is performed continuously;
wherein adding the oxidation agent is performed continuously; and
wherein generating the depleted cerium-praseodymium chloride solution from the mixture is performed continuously.

8. The method according to claim 1, further comprising preparing the high cerium-praseodymium chloride solution by heating the high cerium-praseodymium chloride solution to a temperature between 70° C. and 90° C., where the high cerium-praseodymium chloride solution has a pH less than 1.

9. The method according to claim 1, further comprising determining a concentration of cerium in the high cerium-praseodymium chloride solution; and
adding the oxidation agent such that a molar ratio of cerium to hydrogen peroxide (H₂O₂) is between 2:1 and 1:13.

10. The method according to claim 9, the concentration of hydrogen peroxide (H₂O₂) being 20% to 30% weight/weight solution in water.

11. The method according to claim 10, wherein adding the oxidation agent and agitating the slurry is performed for a time period between 1 hour and 3 hours.

12. The method according to claim 9, wherein the molar ratio of cerium to hydrogen peroxide (H₂O₂) is between 0.9:1 and 1.1:1.

13. The method according to claim 1, wherein the depleted cerium-praseodymium chloride filtrate comprises between 0.1 wt % to 4 wt % of a cerium concentration in the high cerium-praseodymium chloride solution.

14. The method according to claim 13, wherein filtering generates a filter cake comprising the praseodymium oxide with cerium (IV) hydroxide solid; and
wherein the filter cake is a praseodymium oxide solid with 0.9% to 3% of cerium as percentage of total rare earth concentration.

15. The method according to claim 14, wherein the depleted cerium-praseodymium chloride filtrate has at least 98 wt % purity praseodymium oxide (Pr₆O₁₁) on a total rare earth oxide basis.

16. A system for generating depleted cerium-praseodymium chloride solutions, the system comprising:
a vessel in communication with a high cerium-praseodymium chloride solution source, a praseodymium oxide (Pr₆O₁₁) source, and a hydrogen peroxide (H₂O₂) source,
the vessel comprising agitation apparatus; and
a filter unit in fluid communication with the vessel.

17. The system according to claim 16, the filter unit generating:
a solids portion comprising praseodymium oxide solid containing 1 to 2 percent cerium per total rare earth oxides; and
a liquid filtrate comprising a depleted cerium-praseodymium chloride solution with cerium removal rate between 97% to 99%.

18. The system according to claim 17, the vessel comprising temperature regulation components configured to maintain a vessel fluid temperature between about 70° C. to about 90° C.

19. The system according to claim 17, wherein the filter unit is a vacuum filter.

20. The system according to claim 16, further comprising a pH control apparatus configured to maintain a pH of fluid in the vessel at a pH between 3.8 and 5.0.
